(19) United States
(12) Patent Application Publication
(10) Pub. No.: US 2019/0378207 A1
(43) Pub. Date: Dec. 12, 2019

(54) FINANCIAL HEALTH TOOL

(71) Applicant: INTUIT INC., Mountain View, CA (US)

(72) Inventors: Aaron DIBNER-DUNLAP, Mountain View, CA (US); Kevin FURBISH, Tampa, FL (US); Kymm KAUSE, San Jose, CA (US); Swathi NIMMAGADDA, San Jose, CA (US); Nirmala RANGANATHAN, San Jose, CA (US)

(73) Assignee: INTUIT INC., Mountain View, CA (US)

(21) Appl. No.: 16/002,383

(22) Filed: Jun. 7, 2018

(51) Int. Cl. G06Q 40/02; G06Q 30/02; H04L 29/08

(52) U.S. Cl. CPC G06Q 40/02; H04L 67/22; G06Q 30/02

(57) ABSTRACT

A processor may obtain data indicating a user's financial health. The data may include personality data not directly related to finances. The processor may analyze the data to identify a change applicable to a financial account of the user. The change may be configured to improve the user's financial health. The processor may automatically cause the change to be implemented by a network-accessible financial service.

### BRIEF DESCRIPTION OF THE FIGURES

FIG. 1 shows a system configured to evaluate and/or adjust a user's financial health according to an embodiment of the present disclosure.

FIG. 2 shows a server device according to an embodiment of the present disclosure.

FIG. 3 shows a daily pattern determination process according to an embodiment of the present disclosure.

FIG. 4 shows a daily life detail determination process according to an embodiment of the present disclosure.

FIG. 5 shows a future prediction determination process according to an embodiment of the present disclosure.

FIG. 6 shows a volatility determination process according to an embodiment of the present disclosure.

FIG. 7 shows a data set generation process according to an embodiment of the present disclosure.

FIG. 8 shows a setting adjustment process according to an embodiment of the present disclosure.

FIGS. 9A-9F show an example survey according to an embodiment of the present disclosure.

### DETAILED DESCRIPTION OF SEVERAL EMBODIMENTS

Embodiments described herein may be configured to infer a user's preferences and automatically adjust financial account settings and/or options based thereon. Many users may have one or more computer-accessible financial accounts providing various options for spending, saving, transferring, and/or investing money and/or other forms of value. However, many users may not know what set of options would best help them in their current financial situation or which options they should prioritize. As a result, they may simply fail to act, or may act differently from what they should have done to most effectively use their money. The disclosed systems and methods may reduce occurrences of and/or mitigate effects from such mismatches between the benefits offered by financial accounts and the perceived relevance of the benefits to the user. For example, disclosed systems and methods may generate and accumulate knowledge of behavioral biases, values, and personalities (BVPs) for a user from which the disclosed systems and methods may create personalized solutions which users may be more likely to adopt.

An example process for determining a user's financial health and personalizing their finances based on the financial health may proceed as follows. A system may gather data about a user's current and/or historical financial situation (e.g., debt, savings, investments, retirement plans, income pattern, spending pattern, resiliency to financial shock, etc.), data about the user's current and/or historical life situations (e.g., day-to-day life, household situation, life events, lifestyle, etc.), and/or data about the user's future expectations (e.g., wage increases, career advancement, social network changes, retirement strategy, etc.). Thus, the system may gather both financial data and personality data not directly related to finances (e.g., the life situation and future expectation data). The system may analyze the gathered data to determine the user's financial health. The financial health may therefore be based not only on finances, but also on the user's values, priorities, beliefs, personality, cognitive biases, etc. The system may reevaluate the data and adjust the financial health determination as the data changes in some embodiments. Based on the determined financial health, the system may personalize financial account optimizations (e.g., advice, tips, offers, products, etc.). This process, the system that performs the process, and variations thereon are described in detail below.

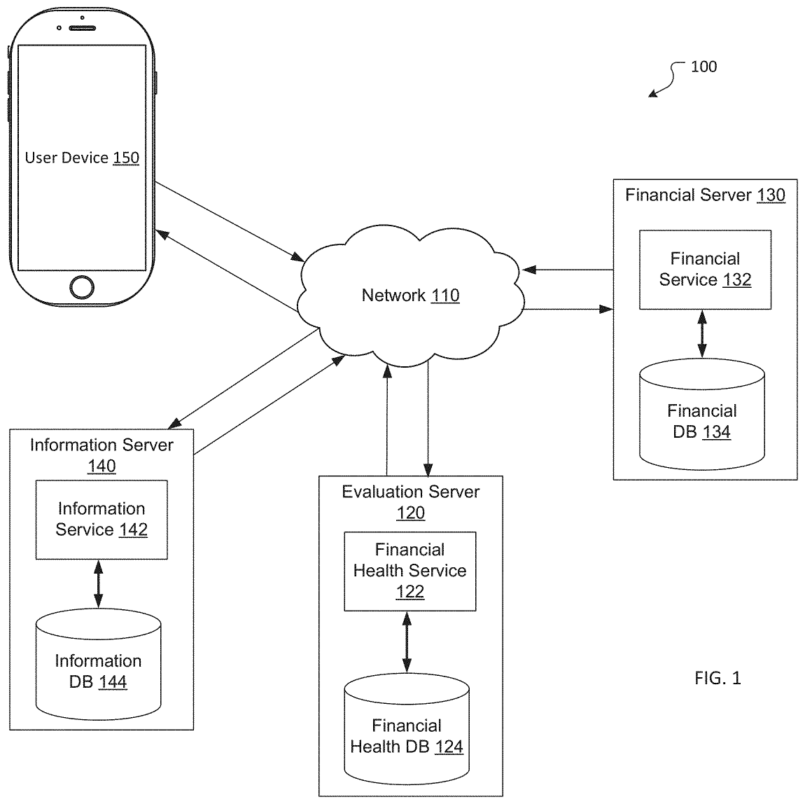

FIG. 1 shows a system 100 configured to evaluate and/or adjust a user's financial health according to an embodiment of the present disclosure. System 100 may include evaluation server 120, financial server 130, information server 140, and/or user device 150. Network 110 may be the Internet and/or other public or private networks or combinations thereof. Evaluation server 120, financial server 130, information server 140, and/or user device 150 may be configured to communicate with one another through network 110. For example, communication between the elements may be facilitated by one or more application programming interfaces (APIs). APIs of system 100 may be proprietary and/or may be examples available to those of ordinary skill in the art such as Amazon® Web Services (AWS) APIs or the like.

Evaluation server 120 may be configured to gather data about a user, evaluate the data, and determine how to adjust user financial account settings based on the evaluating. Evaluation server 120 may include financial health service 122, which may be configured to collect and process the data, and financial health database 124, which may be configured to store the collected data and/or the outcome of the processing by financial health service 122. Detailed examples of the data gathered, the processing performed, and the results generated are provided below.

Evaluation server 120 may communicate with financial server 130 to effect changes in the user's financial account settings. For example, financial server 130 may include financial service 132, which may be configured to process user account changes and/or to generate change suggestions for presentation to the user (e.g., by sending to user device 150) based on data from financial health service 122. Financial server 130 may include financial database 134, which may store account settings and modifications thereto and/or may store offers that may be presented to the user. Detailed examples of the settings, modifications, and offers are provided below.

Evaluation server 120 may gather the data from information server 140 and/or user device 150. For example, information server 140 may include information service 142, which may maintain data about the user in information database 144 and transmit the data to evaluation server 120. Information service 142 may be any network 110 accessible service that maintains personal and/or financial data about the users. A non-limiting example set of information services 142 may include Mint®, TurboTax®, QuickBooks®, QuickBooks Self-Employed®, LinkedIn®, Facebook®, other services, or combinations thereof. Detailed examples of the data gathered from information service 142 are provided below.

User device 150 may be any device configured to present user interfaces and receive inputs thereto. For example, user device 150 may be a smartphone, personal computer, tablet, laptop computer, or other device. User device 150 may facilitate additional data gathering by presenting surveys, questionnaires, or other interfaces to the user. For example, financial health service 122 may transmit survey data to user device 150, allowing user device 150 to present a user interface for filling out the survey and transmitting the survey answers to financial health service 122. For example, the survey may be a form presented on a webpage or within a dedicated app. User device 150 may also present suggestions for modifying financial settings from financial health service 122 and/or financial service 132 for acceptance by the user, requests to confirm automatically adjusted financial settings from financial health service 122 and/or financial service 132, and/or other information. Detailed examples of the data exchanged between user device 150 and other system 100 elements are provided below.

Evaluation server 120, financial server 130, information server 140, and user device 150 are each depicted as single devices for ease of illustration, but those of ordinary skill in the art will appreciate that evaluation server 120, financial server 130, information server 140, and/or user device 150 may be embodied in different forms for different implementations. For example, any or all of evaluation server 120, financial server 130, and information server 140 may include a plurality of servers. Alternatively, the operations performed by any or all of evaluation server 120, financial server 130, and information server 140 may be performed on fewer (e.g., one or two) servers. In another example, a plurality of user devices 150 may communicate with evaluation server 120, financial server 130, and/or information server 140. A single user may have multiple user devices 150, and/or there may be multiple users each having their own user device(s) 150.

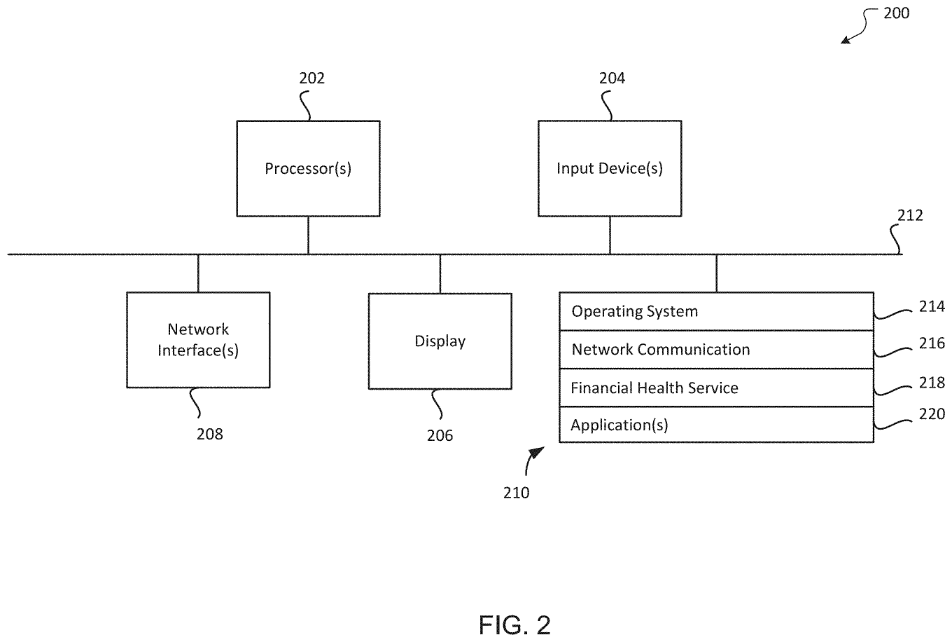

FIG. 2 is a block diagram of an example computing device 200 that may implement various features and processes as described herein. For example, computing device 200 may function as evaluation server 120, financial server 130, information server 140, or a portion or combination thereof in some embodiments. The computing device 200 may be implemented on any electronic device that runs software applications derived from compiled instructions, including without limitation personal computers, servers, smart phones, media players, electronic tablets, game consoles, email devices, etc. In some implementations, the computing device 200 may include one or more processors 202, one or more input devices 204, one or more display devices 206, one or more network interfaces 208, and one or more computer-readable mediums 210. Each of these components may be coupled by bus 212.

Display device 206 may be any known display technology, including but not limited to display devices using Liquid Crystal Display (LCD) or Light Emitting Diode (LED) technology. Processor(s) 202 may use any known processor technology, including but not limited to graphics processors and multi-core processors. Input device 204 may be any known input device technology, including but not limited to a keyboard (including a virtual keyboard), mouse, track ball, and touch-sensitive pad or display. Bus 212 may be any known internal or external bus technology, including but not limited to ISA, EISA, PCI, PCI Express, NuBus, USB, Serial ATA or FireWire. Computer-readable medium 210 may be any medium that participates in providing instructions to processor(s) 202 for execution, including without limitation, non-volatile storage media (e.g., optical disks, magnetic disks, flash drives, etc.), or volatile media (e.g., SDRAM, ROM, etc.).

Computer-readable medium 210 may include various instructions 214 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 204; sending output to display device 206; keeping track of files and directories on computer-readable medium 210; controlling peripheral devices (e.g., disk drives, printers, etc.) which can be controlled directly or through an I/O controller; and managing traffic on bus 212. Network communications instructions 216 may establish and maintain network connections (e.g., software for implementing communication protocols, such as TCP/IP, HTTP, Ethernet, telephony, etc.).

Financial health service instructions 218 may include instructions that generate and evaluate user data and implement financial account optimizations based thereon as described herein.

Application(s) 220 may be an application that uses or implements the processes described herein and/or other processes. The processes may also be implemented in operating system 214.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

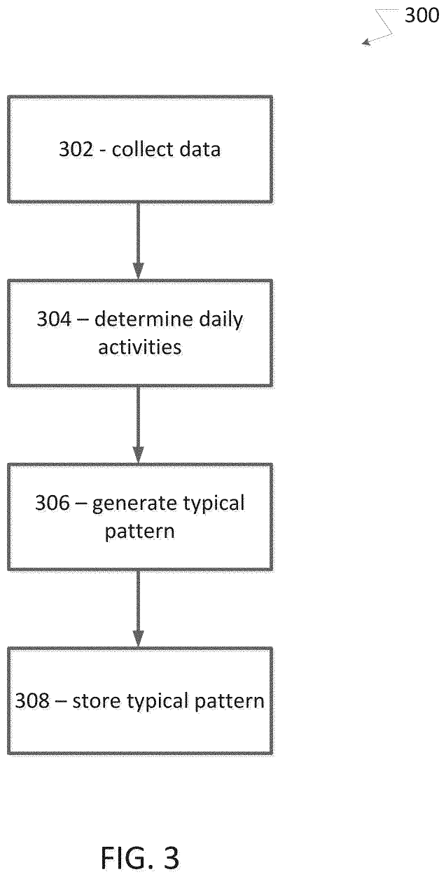

FIGS. 3-6 illustrate processes for gathering data about a user that may provide insight into the user's financial health. System 100 may perform some or all of these processes one time for each user or in a recurring fashion for each user to generate and store data about the user. The stored data may be used to identify modifications that may improve the user's financial health, for example. Note that while the following examples are presented in terms of a single user, the disclosed systems and methods are not limited to a single user, and the term “user” herein may refer to a household of multiple individual, for example, wherein data may be gathered for each individual and processed to give an overall outcome for the household of multiple individuals.

FIG. 3 shows a daily pattern determination process 300 according to an embodiment of the present disclosure. System 100 may determine and store one or more typical daily patterns of a user. There may be more than one pattern because of the nature of the user's job, seasonality, various household members having different daily patterns but all contributing to the user's financial situation, age, social circumstances, etc. A pattern may indicate how much time the user spends on various activities during the day.

Pattern distributions for different users may show a fair amount of variance. For example, the average person sleeps 7 to 8 hours on an average night, but some get a lot less sleep and others get a lot more sleep. Similar principles may apply to work, spending, applying values in daily life, etc. In addition, when a user's financial health is that of a household (e.g., two spouses contributing to joint financial accounts), typical time use may vary for each breadwinner in the household. Moreover, patterns may change over time. For example, an 18-year-old may spend the day differently from an adult who works a single part-time job or multiple jobs. Likewise, the part-time employed adult may spend the day differently from someone works full-time. As users get older and pass retirement age, it may be more likely that their working hours decrease, leaving a lot more time for leisure. Even within users of similar demographics, personal details may allow for a great deal of schedule variance.

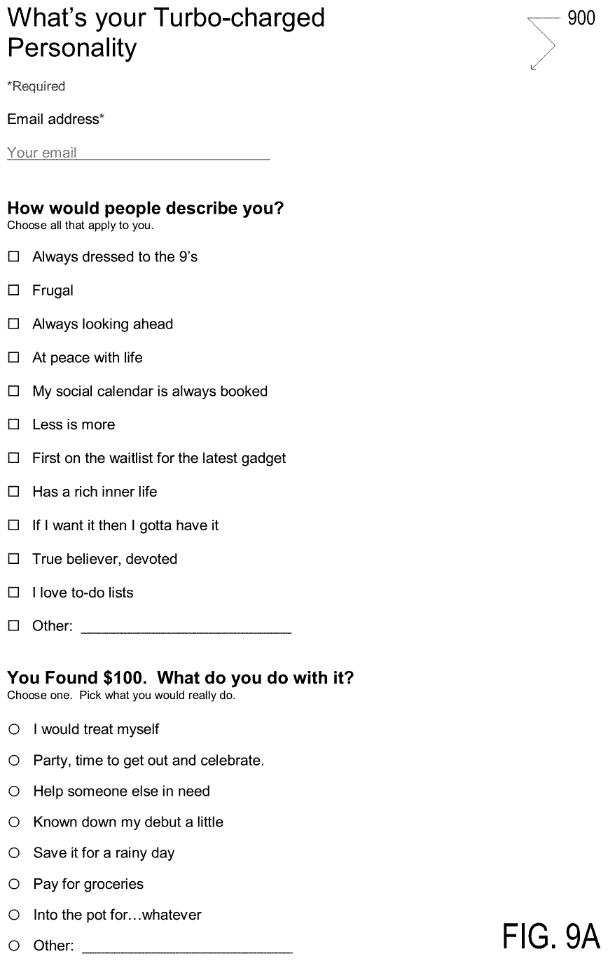

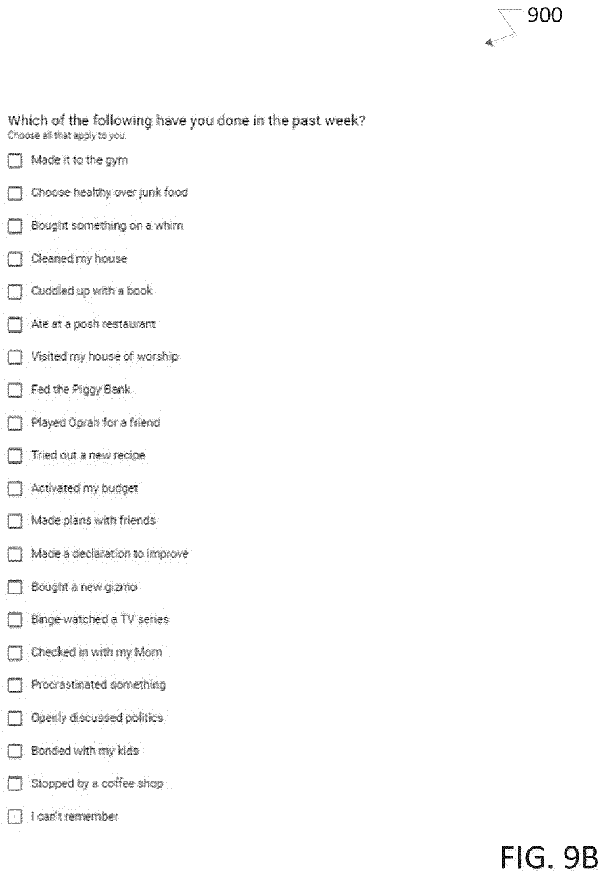

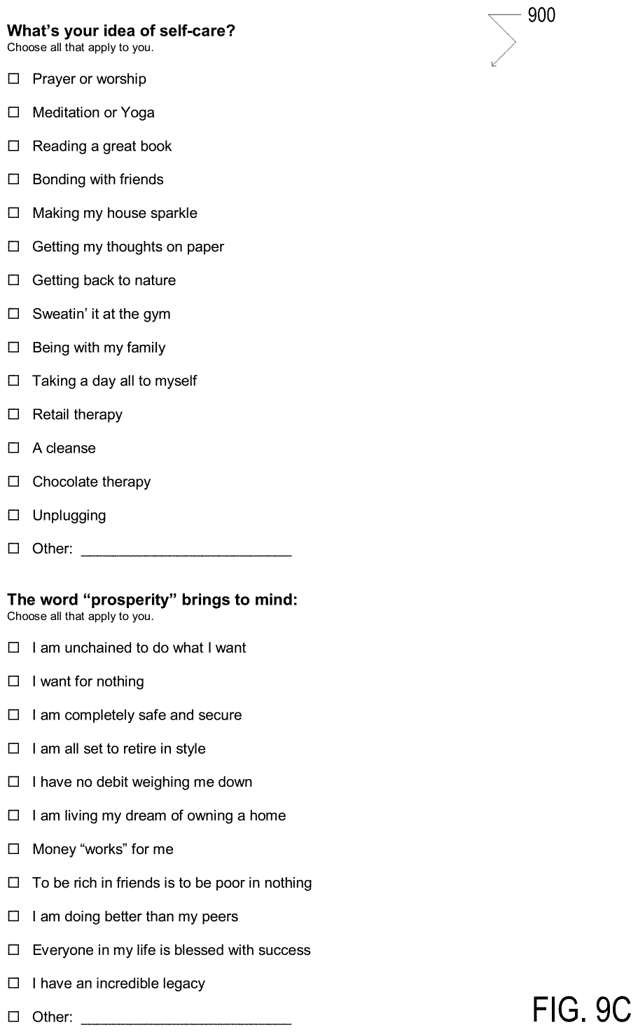

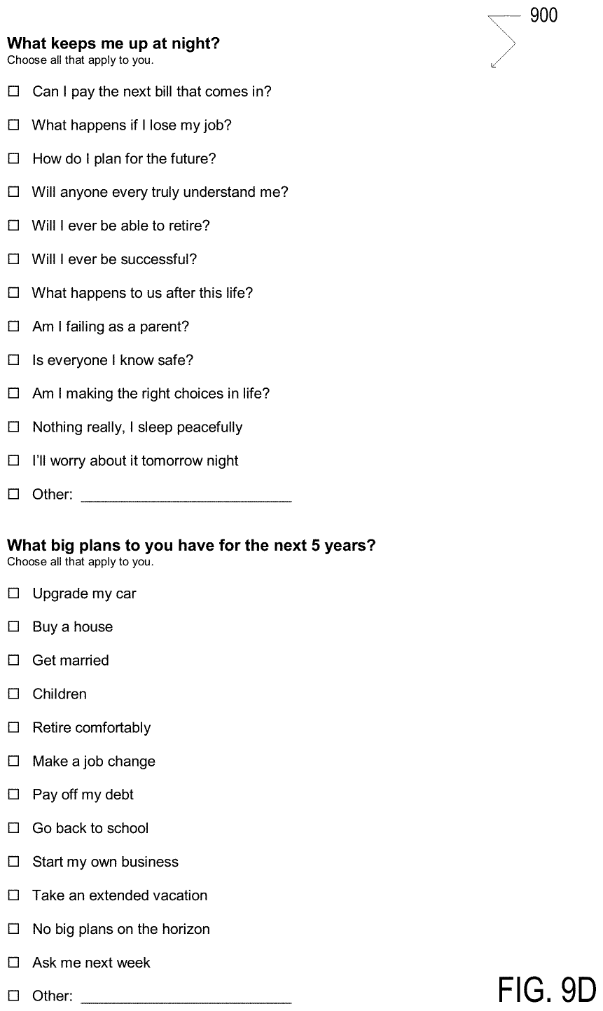

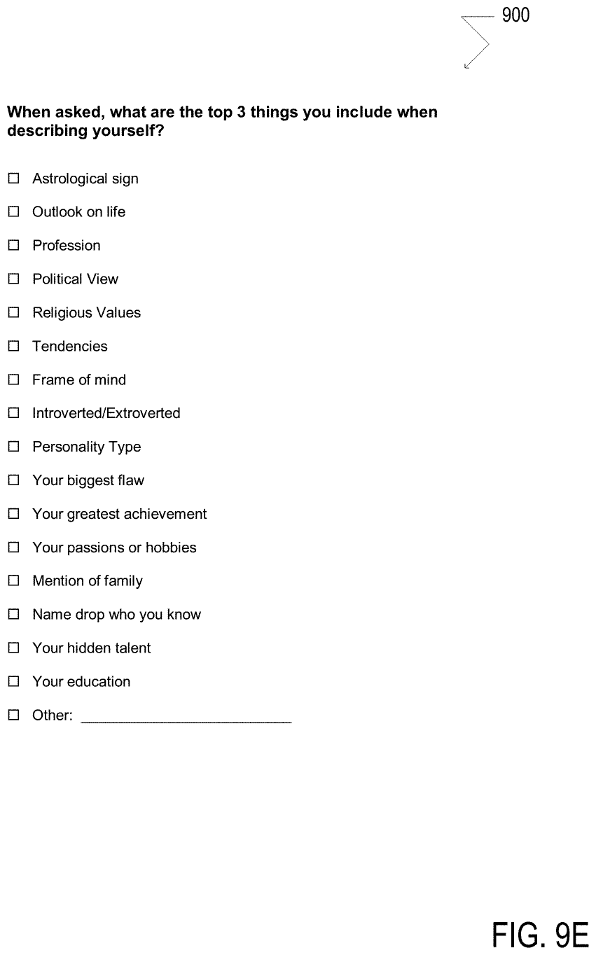

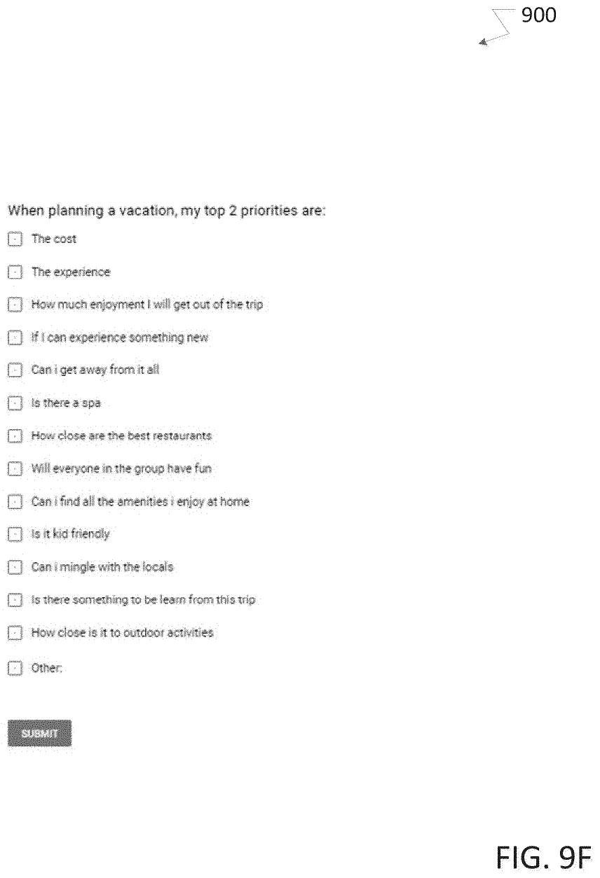

In order to begin determining a user's daily pattern, system 100 may gather information about the user. At 302, system 100 may collect data about the user. For example, financial health service 122 may gather data about the user from financial service 132, information service 142, and/or user device 150 through network 100. Data gathering may include interfacing with financial service 132 and/or information service 142 using one or more APIs, for example. Data gathering may include collecting data by one or more local processes of user device 150, which may then send the data to financial health service 122, for example. Local processes may include data automatically gathered by local applications and/or surveys or other user interfaces presented directly to the user (e.g., see example survey 900 of FIGS. 9A-9F). Some types of data that financial health service 122 may gather may include, but are not limited to, religious and spiritual activities, socializing, relaxing or leisure, professional and personal care services, sleeping, shopping, commuting, traveling, eating and drinking, volunteer activities, household activities (e.g., pay bills, cooking, cleaning etc.), and/or others. Financial service 132 may provide data including expenses and transaction details (e.g., receipt level explanation of what goods or services were purchased in a transaction). Information service 142 may provide data including data about the user (e.g., from a social network or the like) and/or more general data such as government statistics and/or third-party supplied data about cost of living, inflation, taxation, and other expenses particular to certain regions and/or demographics. Financial health service 122 may gather the information over a period of time in a periodic or otherwise repeated fashion (e.g., financial health service 122 may collect user data for 3+ months).

At 304, system 100 may use the collected data to determine the user's daily activities. Determining a granular view of the day-to-day activities may help system 100 personalize the user's path to get to the financial health that they desire. Financial health service 122 may correlate the data from the various sources described above to identify specific activities. For example, financial health service 122 may identify an activity from data reported by user device 150 as follows. User device 150 may report transactions recorded by the Mint app along with locations in which user device 150 was present. Financial health service 122 may correlate the transaction times with the location times to track the user's locations and activities performed at those locations. In other examples, financial health service 122 may correlate other data from other sources (e.g., financial service 132 and/or information service 142) with each other and/or with user device 150 data. As a result, financial health service 122 may identify a plurality of activities performed by the user. Financial health service 122 may repeat such processing as more data comes in over time, which may include identifying repeated activities performed by the user. Some types of activities may be regular (e.g., daily) occurrences, while others may be less frequent. Financial health service 122 may create a data set of financial transactions (e.g., including date, name of business/person with whom money was exchanged), location data, and user provided confirmation/survey data.

At 306, system 100 may generate a typical daily pattern for the user. For example, financial health service 122 may perform data gathering at 302 and processing at 304 repeatedly over a period of time, such as three months or some other period of time including a sampling of multiple days. Financial health service 122 may identify activities that occur frequently at similar times (e.g., the user tends to go to sleep at their home address at a certain time each night) and/or that are representative of the types of activities that occur at certain times (e.g., the user tends to spend money on food at noon every day, but not necessarily in the same place). After a sufficient amount of data has been gathered and processed to identify activities, financial health service 122 may be able to generate data describing the user's typical daily pattern.

At 308, system 100 may store the user's typical daily pattern. For example, financial health service 122 may store the typical daily pattern in financial health database 124. As described below, the stored typical daily pattern may be analyzed to identify and/or implement changes that may improve a user's financial health.

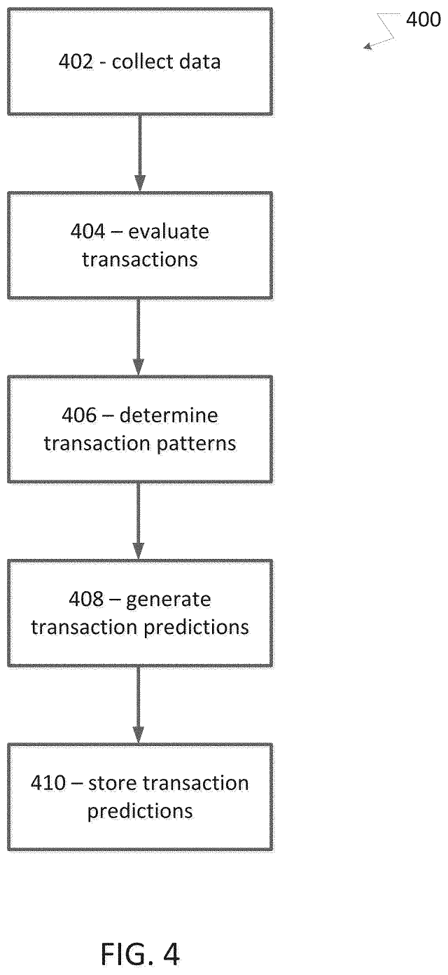

FIG. 4 shows a daily life detail determination process 400 according to an embodiment of the present disclosure. A user's daily life may have short and long term impacts on their financial health. As described below, course correcting small actions and making better tradeoffs (e.g., cooking vs eating out, spending less time on the Internet and more time socializing with friends if prone to shopping online frequently) may lead to a better financial outcome. Accordingly, system 100 may determine daily life details about the user that may aid in predicting how a user may be likely to manage money on a given day in the future.

At 402, system 100 may collect data about the user. For example, financial health service 122 may gather data about the user from financial service 132, information service 142, and/or user device 150 through network 100. Data gathering may include interfacing with financial service 132 and/or information service 142 using one or more APIs, for example. Data gathering may include collecting data by one or more local processes of user device 150, which may then send the data to financial health service 122, for example. In some embodiments, data generated by process 300 and stored in financial health database 124 may be among the data collected. Relevant data for determining daily life details may include data from financial transactions, locations, appointments from calendars, wallet/billing tools (e.g. PayPal, Venmo, Square, bitcoin wallets), emails, etc. Financial service 132 may provide data including expenses and transaction details (e.g., receipt level explanation of what goods or services were purchased in a transaction). Information service 142 may provide data including data about the user (e.g., from a social network or the like) and/or more general data such as government statistics and/or third-party supplied data about cost of living, inflation, taxation, and other expenses particular to certain regions and/or demographics.

At 404, system 100 may evaluate the data to identify transactions indicated by the data. For example, financial health service 122 may inspect the data to identify information indicative of transactions. In some embodiments, financial health service 122 may scan emails for purchases from ecommerce sites and other invoice-sending vendors and store the date, time, amount, and/or category of purchase. In some embodiments, financial health service 122 may scan calendar appointments to correlate the date and time of a financial transaction to a calendar appointment to add information about what the user was doing and/or who they were with during a transaction. In other examples, financial health service 122 may identify transaction-related data from other sources (e.g., billing tools and/or banking records including transaction data, etc.). Data from these sources may provide a picture of a user's non-cash transactions, the locations they are when they make purchases, and/or who they're with and what they're doing.

At 406, system 100 may analyze the transactions and/or other data to determine financial patterns. For example, financial health service 122 may analyze the transaction data, financial data from financial service 132, and/or user data from information service 142 and/or user device 150 (e.g., personal data gathered as described above in process 300). Financial health service 122 may determine financial patterns (e.g., money coming in, money going out) on one or more scales, such as daily, weekly, monthly, and/or yearly. Financial health service 122 may determine the amount of time that passes between recurring transactions. Financial health service 122 may use one or more methods to determine if there is a regular pattern and, if so, the frequencies of re-occurrences (e.g., using Fourier transformations, statistics (average, median, mode) on the distribution of deltas between recurring transactions, and/or auto-correlation).

As part of the analysis, financial health service 122 may generate a daily life score for the user (e.g., to help identify similar users at 408 as described below). Financial health service 122 may compute the daily life score using some or all of the following data, for example: household size, relationships (family and friends), finances (day-to-day basis), health, interests/hobbies, job(s), living environment, and/or pattern of the day (e.g., derived by process 300).

To generate the daily life score, financial health service 122 may collect a summary of a user's daily data, their preferences, and/or what determines their personality and/or their values. This data, which may include financial and/or non-financial data, may be provided by the users and/or collected from user interaction with financial accounts and/or financial software tools. For example, financial health service 122 may scrape financial/purchasing information from user emails and calendars to which financial health service 122 may have been granted access, from survey data, and/or through approved third party vendors. Financial health service 122 may obtain a daily measure of what the daily life/spending of a user looks like based on attributes such as household size, age, credit profile, savings, loans, investments, relationships (family and friends), finances (day-to-day basis), health, interests/hobbies, priorities, likes/dislikes, values, goals, budgeting, job(s), living environment, and/or pattern of their day based on the relevancy.

Financial health service 122 may assign a daily life score or value from 1-10 based on how well the user is doing in life. Any small change in the behaviors (e.g., spending or non-spending changes) may affect one's daily life score. The daily life score may be based on how a user is doing with their finances, their daily activities, habits, values, and/or preferences. For example, for a student, the daily life score might be based on how well he/she is saving, their daily financial/non-financial habits, and on how they compare with others will similar lifestyle or their goals.

To identify and provide recommendations to influence a user behavior based on the daily life score, financial health service 122 may gather the prior mentioned attributes on a daily basis irrespective of when the recommendation is provided to the user. This may help financial health service 122 to analyze the lifestyle, preference, values, personality biases, and spending patterns of users and thereby provide personalized recommendations to an individual rather than generalizing. Some example analyses that may be performed may include, but are not limited to, the following:
Data regarding users' financial information, their hobbies, and day to day activities (based on transactions and categories) data may be obtained.
Cost of living (COL) may be calculated for the users to be used as a feature to predict the daily life score. COL may be calculated by using users' median monthly income required to cover their median monthly cost of living. Median monthly value may be calculated over the previous six months, for example.
Predicted and user provided goals data, previously gathered as described below, may contribute to the daily life score.
Daily score calculation:
   Personality, values, and behavior data may be joined with other datasets such as household size, age, credit profile, savings, loans, investments, finances (day-to-day basis), health (based on the transactions, goals, insurances, co-pay), interests/hobbies (based on the expenses or goals), priorities (based on the discretionary spending/goals/categories), values, goals, budgeting, job(s) (num-W2, business income, other income), COL, and/or pattern of user's day (everyday transactions) based on the relevancy may be used to predict the daily life score of 1-10.
   Biased weights may be assigned to the features, weights (summing up to 1) may be assigned to the features based on the importance of the feature before performing a training process using a regression model, and the weights may be adjusted to account for a relation between the features and the daily score. For example, savings may be weighed higher than investments. A utility matrix may be created to identify which feature is most important for the daily life score.
With so many features listed above that may be taken into consideration for calculating a life score, financial health service 122 may have high dimensional data. So, dimensional reduction using PCA (principal component analysis) may be performed to narrow down the dimensions for better predictability. Financial health service 122 may take the most significant principal components that have a cumulative explained variance above a percentage selected through experimentation.

At 408, system 100 may generate one or more predictions about future transactions based on the financial patterns. For example, financial health service 122 may compare data from similar users with similar financial patterns (e.g., users having similar daily life scores) to generate predictions. Data about similar users may be available in financial health database 124. Based on the user's past transactions and transactions by similar users, financial health service 122 may make predictions about when and what type of future transactions the user may attempt. For example, financial health service 122 may fill in a calendar data structure with expected spending by the day, week, month, and/or year.

Financial health service 122 may utilize a variety of techniques to generate predictions. For example, financial health service 122 may create an initial calendar of predicted financial transactions for a user based on past recurring transactions for the user. Financial health service 122 may update the calendar as new transactions occur, updating the calendar using similar financial transactions (e.g., transactions with another common entity and/or in a same transaction category) that have occurred more than once. For example, the first time a purchase with Amazon occurs, financial health service 122 may not update the calendar. However the second time a transaction with Amazon occurs, financial health service 122 may evaluate Amazon-related transactions to see if there is a recurring pattern that should be added to the calendar. Similarly, repeated purchases categorized as Auto Fuel may be considered as repeating purchases even if they are with different gas stations.

Financial health service 122 may use natural language processing (NLP) and/or topic modeling to analyze the content of emails, calendars, and/or text feedback that users provide to identify data related to user activity and, therefore, identify transaction categories and/or entities. For example, financial health service 122 may recognize terms by applying a trained NLP model (e.g., a multinomial classifier based on logistic regression or naïve Bayes) to text associated with the accounts and transactions in an event stream, such as the names of each of the accounts (e.g., an account named “Mortgage”) and/or descriptions of the transactions (e.g., a description stating “payment to IRS”. The NLP model may be trained on the entire dataset of a multi-user online accounting service in some embodiments.

When financial health service 122 observes a transaction with a common description or category, it may use one or more of the following methods to determine whether the transaction appears to be periodic:
Financial health service 122 may calculate a fast Fourier transform (FFT) on the time series of transactions. To determine the periodicity of the set of transactions financial health service 122 may look at common time periods (e.g., quarterly, yearly, every six months, 180 days, 1-31 days, every other month, every 1/2/3/4 weeks, etc.) and measure how close the transaction dates are to peaks in the FFT to find how well the transaction time series fits the tested periodicity. If the metric is above a threshold, financial health service 122 may consider the test time period to fit the periodicity for the transaction series.
Financial health service 122 may create a list of the number of days between transactions and take the mode of that distribution.
Financial health service 122 may determine if the transaction series is primarily on a specific day of week/month/year.

If financial health service 122 uses multiple methods, and the multiple methods compute different periodicities, financial health service 122 may use the periodicity that correctly predicts the date of the most number of transactions. Using that predicted periodicity, financial health service 122 may fill in a calendar with the day(s) that a repeating transaction is predicted to occur. This may be done for both income and expenses to create a picture of money in and money out flows.

In some embodiments, financial health service 122 may predict the amounts of predicted transactions. For example, financial health service 122 may evaluate periodic transactions to determine whether they represent commitments (e.g., consistent payment values on consistent dates, such as installment payments), patterns (e.g., daily lunch purchases of varying cost), or random transactions, based on the periodicity fit described above.

For example, if the pattern is a commitment, financial health service 122 may determine the implications of missing a cash payment, e.g., a penalty and/or interest. Additionally or alternatively, financial health service 122 may determine any flexibility with respect to a cash payment, e.g., whether there is a grace period to make the cash payment or an extension fee that might be paid. If the pattern is a repeated pattern, financial health service 122 may determine a frequency and a value for the pattern, e.g., an average payroll of $225,000 is due approximately every 14 days. If the pattern is a random pattern, financial health service 122 may determine a probability distribution for the pattern based on features (e.g., arising from a user's financial data or from the aggregate financial data of some or all of the users of the accounting service) input to a model (e.g., based on time series modeling, logistic regression, random forests, gradient boosting, etc.) that predicts future transactions and/or identifies rare events or anomalies.

After characterization of a pattern in an event stream, financial health service 122 may predict cash payments and payment dates and/or and combinations of cash payments and payment dates. For example, if the characterization is for a commitment, financial health service 122 may apply rules, e.g., decision trees, an inference engine, etc., to predict an expected value (e.g., a measure of location) for the amount of a cash payment and an expected value for the date when the cash payment might occur. In some embodiments, financial health service 122 may provide a measure of uncertainty (e.g., a measure of dispersion (e.g., a confidence interval, a range, a standard deviation, etc.)) associated with the predicted expected values. In some embodiments, the measure of uncertainty for the expected value of the amount of a cash payment may be based on a probability distribution specific to that expected value. In some embodiments, the measure of uncertainty for the expected value for the date may be based on another probability distribution. In some embodiments, the expected values for the amount of the cash payment and the date may be based on a joint probability distribution.

For some types of commitments (e.g., bills, invoices, credit cards, etc.), financial health service 122 may create event substreams related to the commitment event stream and use expected values (e.g., for amount and date) for the substreams to predict the expected values (e.g., for amount, date, carryover amount, etc.) of the commitment stream. In one example, the substreams may be the charges against a credit card, e.g., transactions between a credit card account and expense accounts that are not cash accounts. Each of these substreams of charges may be identified as a commitment itself or as a repeated pattern (using FFT) or random pattern (e.g., using time series models). Then using the corresponding characterization for the identified pattern, financial health service 122 may predict expected values (e.g., for amount and date) as well as a measure of uncertainty for each of the substreams during a credit card billing period and combine these predictions and measures of uncertainty to predict the expected values (e.g., for amount, date, carryover amount, etc.) and associated measures of uncertainty for the credit card commitment at the end of the credit card billing period.

If the characterization is for a repeated pattern, financial health service 122 may use regression (e.g., logistic, linear, nonlinear, etc.) or time-series model (e.g., ARIMA, exponential smoothing, recurrent neural networks, deep-learning time series, etc.) to predict an expected value for the amount of a cash payment and an expected value for the date when the cash payment might occur and might also provide a measure of uncertainty (e.g., a confidence interval, a range, a standard deviation, etc.) associated with the predicted expected values. In some embodiment, the expected date or dates for a set of payments may be predicted as a continuation of the historically observed repeated pattern. In some embodiments, if the characterization is for a random pattern, financial health service 122 may use a time-series model (e.g., ARIMA, exponential smoothing, recurrent neural networks, deep-learning time series, etc.) or a simulation (e.g., a Monte Carlo simulation) to predict an expected value for the amount of a cash payment and an expected value for the date when the cash payment might occur and might also provide a measure of uncertainty associated with the predicted expected values (e.g., a confidence interval, a range, a standard deviation, etc.). In some embodiments, the measure of uncertainty for the expected value of the amount of a cash payment may be based on a probability distribution specific to that expected value. in some embodiments, the measure of uncertainty for the expected value for the date may be based on another probability distribution. In some embodiments, the expected values for the amount of the cash payment and the date might be based on a joint probability distribution.

At 410, system 100 may store the user's predictions. For example, financial health service 122 may store the predictions in financial health database 124. As described below, the stored predictions may be analyzed to identify and/or implement changes that may improve a user's financial health.

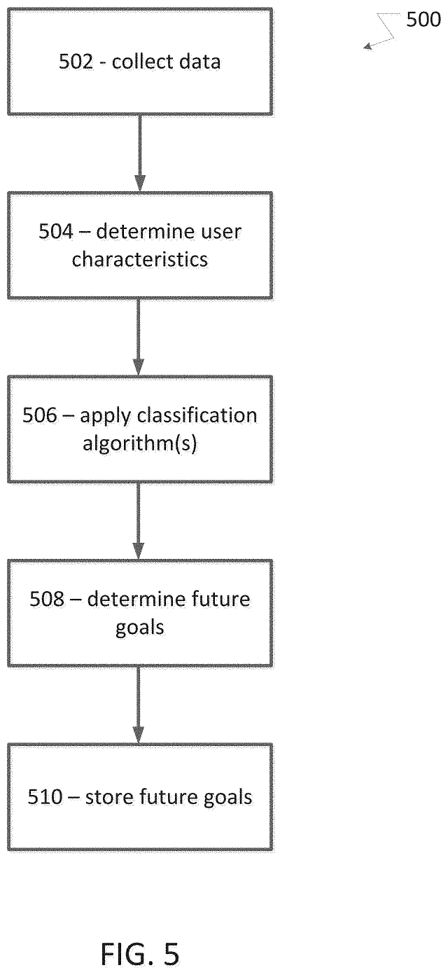

FIG. 5 shows a future prediction determination process 500 according to an embodiment of the present disclosure. Users may have future goals and/or interests which may impact how account settings may be optimized. Process 500 may identify and/or determine likely future goals to facilitate such optimization. Examples of future goals may include, but are not limited to, the following: saving for retirement, advancing skills, learning new skills, earning for a few years and then going back to school, starting a business, career advancement, increase in income trend, saving for kids' education, buying a home, traveling to new places, taking an extended vacation, contributing to the community, and/or staying fit and healthy. As described below, modifying financial settings based on future goals may take into account the user's values, meaning of self-care, priorities/goals, and/or daily lifestyle to forecast the future in various paths and help choose a path of least resistance (e.g., including modifying expectations, making correct trade-offs, and sticking to a plan).

At 502, system 100 may collect data about the user. For example, financial health service 122 may gather data about the user from financial service 132, information service 142, and/or user device 150 through network 100. Data gathering may include interfacing with financial service 132 and/or information service 142 using one or more APIs, for example. Data gathering may include collecting data by one or more local processes of user device 150, which may then send the data to financial health service 122, for example. In some embodiments, data generated by process 300 and/or process 400 and stored in financial health database 124 may be among the data collected. Financial service 132 may provide data including expenses and transaction details (e.g., receipt level explanation of what goods or services were purchased in a transaction). Information service 142 may provide data including data about the user (e.g., from a social network or the like) and/or more general data such as government statistics and/or third-party supplied data about cost of living, inflation, taxation, and other expenses particular to certain regions and/or demographics.

At 504, system 100 may determine user characteristics. For example, financial health service 122 may use data gathered for and/or generated by process 300 and/or process 400 to describe and/or classify the user. User characteristics may include data gathered from financial service 132, information service 142, and/or user device 150. User characteristics may include a daily pattern, a daily life score, and/or future predictions.

At 506, system 100 may apply classification algorithms to the user characteristics. For example, financial health service 122 may use data about the user's values and/or short term spending priorities, along with data about existing users who have provided data about their long term goals (e.g., gathered in similar fashion for the other users, such as according to process 300 and/or process 400), and apply one or more classification algorithms (e.g. K-nearest neighbors, decision tree based algorithms, SVM, naive Bayes, etc.) to identify existing users who may be similar in terms of values and/or short term spending priorities.

At 508, system 100 may determine future goals for the user. For example, financial health service 110 may use data about the long term goals of users determined to be similar to the user by the classification algorithms to predict long term goals that may be relevant for the user. In some embodiments, identifying future goals for the user based on recommendation engines described above may be just one way of determining the common future goals. Data gathered at 502 may identify unique/specific future goals for the user based on user daily lifestyle and/or priorities/goals (e.g., based on user social media data of planning to attend a graduation event 3 months from now, along with increase in future travel airfare/hotel, may predict a future goal of traveling to graduation). The user characteristic recommendation engine at 504 and user calendar data structure at 408 may aid in determining the user's future goal. For example, there could be a change in the user daily spending pattern (e.g., the user consistently had daily expenses at Starbucks, but within the last month, expenses at Starbucks decreased by a measured percentage, therefore, the user may be attempting to cut down on discretionary spending). Financial health service 110 may identify a future goal of decreasing discretionary spending without the user specifying this as a goal.

At 510, system 100 may store the user's future goals. For example, financial health service 122 may store the future goals in financial health database 124. As described below, the stored future goals may be analyzed to identify and/or implement changes that may improve a user's financial health.

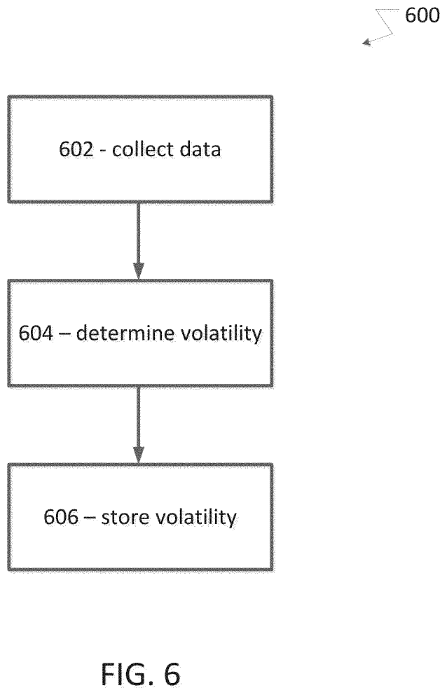

FIG. 6 shows a volatility determination process 600 according to an embodiment of the present disclosure. Users may have different levels of income volatility, based on how predictable their income may be. Income volatility may refer to monthly and annual dips and jumps in income that users may experience. Users with unpredictable income streams may find it difficult to follow traditional or conventional advice on financial decisions. For example, standard advice on how much house the user can afford based on overall salary may not apply to a user with a highly volatile income stream. Users with volatile income may have a hard time budgeting, sticking to a goal, estimating how much of a tax refund they'll get, or whether they'll qualify for tax breaks like the earned income tax credit, for example. Accordingly, income volatility may be a contributor to financial health and may affect how to optimize financial account settings.

At 602, system 100 may collect data about the user. For example, financial health service 122 may gather data about the user from financial service 132, information service 142, and/or user device 150 through network 100. Data gathering may include interfacing with financial service 132 and/or information service 142 using one or more APIs, for example. Data gathering may include collecting data by one or more local processes of user device 150, which may then send the data to financial health service 122, for example. In some embodiments, data generated by process 300, process 400, and/or process 500 and stored in financial health database 124 may be among the data collected. Financial service 132 may provide data including expenses and transaction details (e.g., receipt level explanation of what goods or services were purchased in a transaction). Information service 142 may provide data including data about the user (e.g., from a social network or the like) and/or more general data such as government statistics and/or third-party supplied data about cost of living, inflation, taxation, and other expenses particular to certain regions and/or demographics.

At 604, system 100 may determine the user's income volatility. For example, financial health service 122 may analyze the data to detect income irregularities that may indicate volatility. Income may be irregular in at least two ways. The amount received may be irregular, and/or the frequency of receiving income may be irregular. Experiencing either may make household planning difficult, and experiencing both may make it even more challenging. Financial health service 122 may measure volatility in the amount of income in at least one of the following ways. First, financial health service 122 may determine a count of the number of units of a time period where the income is above or below a normal income level, allowing for some variability (e.g., the number of months where income is above or below a typical month's income). Second, financial health service 122 may determine the coefficient of variation of a distribution of incomes in a time period (e.g. monthly, bi-weekly, weekly, quarterly, etc.). For example, coefficient of variation may be computed as the standard deviation of a distribution divided by the mean of the distribution. Financial health service 122 may also measure volatility in the regularity of receiving income using the same methods to detect regularity as described above for calculating the daily life score. Financial health service 122 may then calculate the monthly percentage of income that can be detected as falling into a regular schedule pattern and use that as a metric for volatility.

At 606, system 100 may store the user's income volatility. For example, financial health service 122 may store the income volatility in financial health database 124. As described below, the stored income volatility may be analyzed to identify and/or implement changes that may improve a user's financial health.

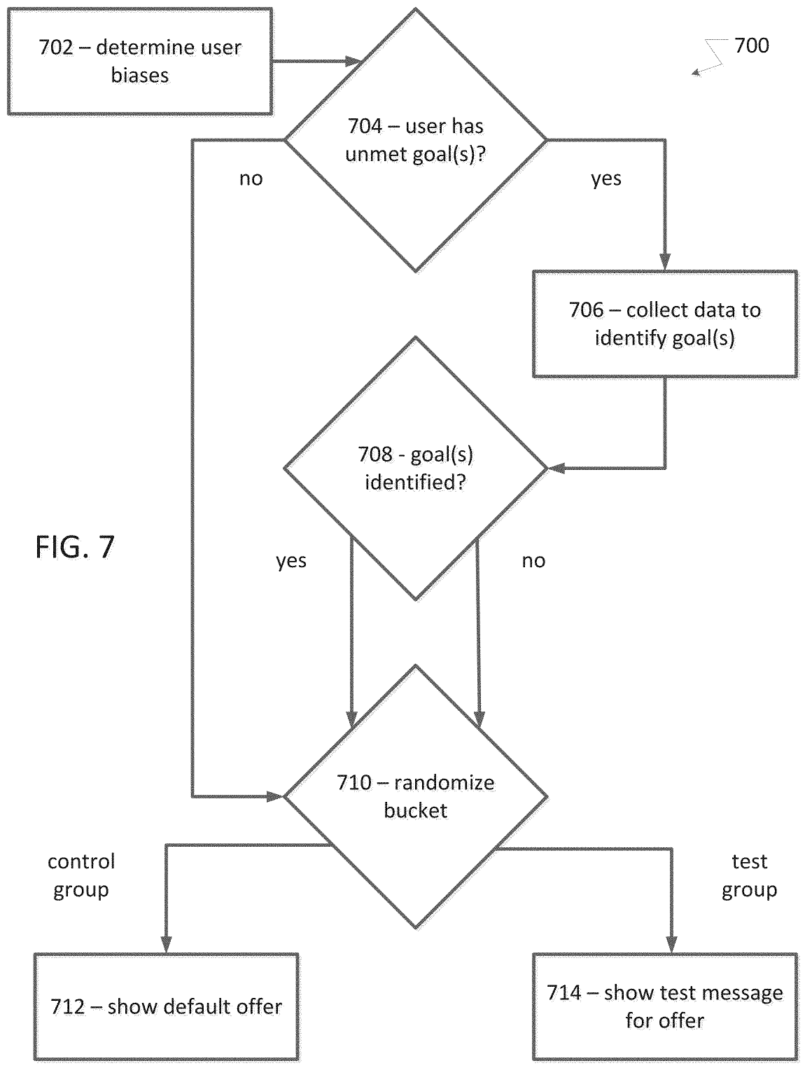

FIG. 7 shows a data set generation process 700 according to an embodiment of the present disclosure. System 100 may use process 700 to gather a portion of the data about a user and/or to build a data set against which to test users for similarities. For example, as described above, at least a portion of data utilized by processes 300, 400, 500, and/or 600 may be user-provided data about interests, biases, goals, etc. Furthermore, portions of processes 300, 400, 500, and/or 600 may rely on data about similar users to generate insights about specific users. Process 700 may gather data about similar users. Process 700 may also determine which account setting adjustments appeal to different types of users.

At 702, system 100 may determine user biases. For example, user device 150 may present a user interface posing questions to the user. The user may provide responses to the questions, and user device 150 may send the responses to evaluation server 120. The responses may indicate data about the user's biases. Financial health service 122 may store the data about the user's biases in financial health database 124.

To elicit responses about the user's biases, user device 150 may present a scenario to the user and may ask questions about how the user would deal with the scenario. For example, user device 150 may ask how the user would approach establishing an emergency fund. User device 150 may provide a series of options which may be selected and/or ranked by the user. For example, user device 150 may suggest some or all of the following non-limiting possible responses: automatically move $5/week to a rainy day account, automatically transfer tax refund or bonus to savings, set aside leftover money at the end of the month to an emergency fund, get a second job or side hustle to put towards savings, sell unused items and put proceeds towards savings, eat out less and move savings into emergency fund, make cuts to travel plans for next year, set a calendar reminder to move money into savings each week, seek help from friends and family during an emergency, treat emergency fund as debt and pay each month towards it, initiate impulsive savings when I make impulsive purchases, and/or use a credit card balance during emergencies and pay it later.

In another example, user device 150 may ask how the user would approach paying off debt. User device 150 may provide a series of options which may be selected and/or ranked by the user. For example, user device 150 may suggest some or all of the following non-limiting possible responses: automatically move $5/week towards debt, automatically transfer tax refund or bonus to debt payment, set aside leftover money at the end of the month to pay debt, get a second job or side hustle to put towards debt, call service providers (e.g., insurance, credit card, cable, etc.) to look for cost-saving opportunities, eat out less and move savings into debt repayment, make cuts to travel plans for next year, set a calendar reminder to pay down debt each week, seek help from friends and family to pay off debt, pay the minimum and deal with the debt later, initiate impulsive debt payment when I make impulsive purchases, and/or open a balance-transfer credit card.

At 704, system 100 may determine whether the user has unmet goal(s). For example, user device 150 may present a user interface posing questions to the user. The user may provide responses to the questions, and user device 150 may send the responses to evaluation server 120. The responses may indicate whether the user has goals that they are attempting to meet. If the user does not have unmet goals, financial health service 122 may label the user as having no unmet goals.

At 706, if the user has unmet goals, system 100 may collect data to identify the user's goals. For example, user device 150 may present a user interface posing questions to the user. The user may provide responses to the questions, and user device 150 may send the responses to evaluation server 120. The responses may indicate data about the user's goals. Examples of future goals may include, but are not limited to, the following: saving for retirement, advancing skills, learning new skills, earning for a few years and then going back to school, starting a business, career advancement, increase in income trend, saving for kids' education, buying a home, traveling to new places, taking an extended vacation, contributing to the community, and/or staying fit and healthy. User device 150 may ask questions intended to identify such goals. Financial health service 122 may store the data about the user's goals in financial health database 124. At 708, financial health service 122 may label the user as having unmet goals that are identified or unidentified based on the responses.

At 710, system 100 may randomize the user as either a member of a control group or a test group. For example, financial health service 122 may designate the user as having no unmet goals and being part of the control group, as having identified unmet goals and being part of the control group, as having unidentified unmet goals and being part of the control group, as having no unmet goals and being part of the test group, as having identified unmet goals and being part of the test group, or as having unidentified unmet goals and being part of the test group.

At 712, if the user is part of the control group, system 100 may present a default offer to the user. The default offer may be an offer to adjust a specific account setting, as described in greater detail below. The default offer may be an offer that is not specifically tailored to the user's bias. User device 150 may present the offer and receive approval or refusal of the offer from the user. User device 150 may send the selection to evaluation server 120. Financial health service 122 may record the selection in financial health database 124. By aggregating multiple users' responses to the default offer, financial health service 122 may determine which users (e.g., classified by bias and/or goal status) find the default offer appealing.

At 714, if the user is part of the test group, system 100 may present a test offer to the user. The test offer may be an offer to adjust a specific account setting, as described in greater detail below. The test offer may be an offer that is specifically tailored to the user's bias (e.g., in order to help the user meet account-related goals in a manner towards which they are biased). User device 150 may present the offer and receive approval or refusal of the offer from the user. User device 150 may send the selection to evaluation server 120. Financial health service 122 may record the selection in financial health database 124. By aggregating multiple users' responses to the test offer, financial health service 122 may determine whether the test offer is appealing for its intended audience (e.g., users having a certain bias and/or goal status) or not.

Based on the testing at 712 and 714, financial health service 122 may determine how users having given characteristics may respond to and/or benefit from given offers. For example, when a user having a given set of biases responds positively to a given offer, financial health service 122 may record this relationship and may be more likely to suggest the offer to users with similar biases in the future. Likewise, when a user having a given set of biases responds negatively to a given offer, financial health service 122 may record this relationship and may be less likely to suggest the offer to users with similar biases in the future. This data may be accumulated and stored in financial health database 124. As described below, this data may be used to identify and implement changes to a user's account settings.

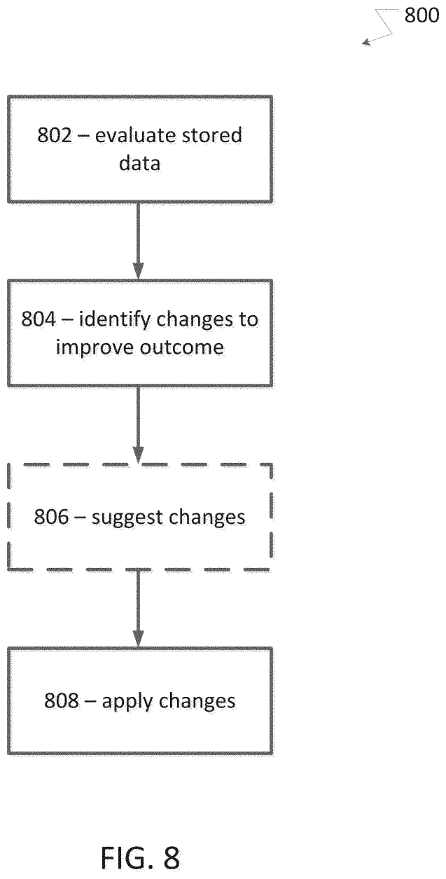

FIG. 8 shows a process 800 according to an embodiment of the present disclosure by which system 100 may identify and implement changes to a user's account settings based on the user's specific characteristics (e.g., as determined by processes 300, 400, 500, and/or 600).

At 802, system 100 may evaluate the user's stored data. For example, financial health service 122 may access the user's typical daily pattern, daily life score, future predictions, future goals, and/or income volatility stored in financial health database 124. Financial health service 122 may also access data stored in financial health database 124 indicating how users having typical daily patterns, daily life scores, future predictions, future goals, and/or income volatilities similar to the current user have responded to account modification offers. Based on this information, financial health service 122 may determine one or more potential actions that may be beneficial to the user. For example, based on data gathered through process 700, financial health service 122 may identify actions that may be of likely interest to the user because they were of interest to similar users in the past. Such actions may include periodically moving money from checking to savings, establishing reminders to perform certain account-related and/or finance-related tasks (e.g., money transfers, payments, suggestions to spend more or less on certain types of expenses, etc.), opening credit or banking accounts, and/or other tasks.

At 804, system 100 may identify potential changes to the user's accounts based on the evaluation at 802. For example, financial health service 122 may receive information about the user's financial accounts from financial service 132. Financial health service 122 may evaluate this information to determine which, if any, of the actions identified at 802 may be appropriate modifications to the user's accounts as they are currently configured. For example, financial health service 122 may determine that the user maintains enough money in a checking account to regularly transfer money from the checking account to an interest-bearing savings account, thereby improving a financial outcome by collecting interest on idle money. In another example, financial health service 122 may determine that the user is qualified for a specific type of credit card and does not already have such a credit card. This credit card may improve a financial outcome by offering substantial rewards on a type of purchase the user makes often, for example. These are presented only as possibilities, and those skilled in the art will understand that any type of financial account modification may be identified.

In some embodiments, financial health service 122 may perform content based recommendation. Financial health service 122 may use NLP and/or topic modeling to analyze the content of emails, calendars, and/or text feedback that users provide to identify data related to user activity. For example, by analyzing data and items that the user has purchased and/or appointments and interests the user has, financial health service 122 may recommend actions that the user may take based on these attributes.

In some embodiments, accuracy of the recommendations made by financial health service 122 may be enhanced according to one or more of the following methods:
Financial health service 122 may use the weights assigned for calculating the daily life score as mentioned above for recommendations. Based on the weights of the features, financial health service 122 may determine the importance of a feature and provide recommendations related to that feature. Based on the recommendation and the action taken by the user for that feature, the daily life score may improve.
Financial health service 122 may use collaborative filtering by finding people with similar interests, performing a behavior analysis on those people, and recommending the same actions performed by those people with similar cosine distance to the user.

At 806, system 100 may optionally notify the user of possible changes to their account and request confirmation of the changes before implementing them. For example, user device 150 may present information about the changes identified by financial health service 122 and request user approval. In some embodiments, this action may provide system 100 with an opportunity to bootstrap the data used to make decisions about changes for future users. For example, user device 150 may provide advice to the user on how much money they will need and how to prepare so they can achieve a given goal and/or provide an estimate for how long it will take to reach the goal. User device 150 may provide an explanation of how the proposed change may help reach the goal. To bootstrap system 100, user device 150 may ask the user how much money they believe they will need for certain goals such as starting a new business (and validate with data on how much each goal will cost, the place the user lives, inflation, etc.), and over time system 100 may aggregate these answers and, as more time passes and goals are reached, determine how much money is actually required and use this information in future advice to users.

At 808, system 100 may apply the identified changes to the user account. For example, if user approves the changes, user device 150 may inform financial health service 122 of the approval, and financial health service 122 may direct financial service 132 to change the account setting. In some embodiments, financial health service 122 may direct financial service 132 to change the account setting proactively (e.g., without user approval).

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method of identifying and implementing an account change comprising:
obtaining, at a processor, data indicating a user's financial health, the data including personality data not directly related to finances;
analyzing, by the processor, the data to identify a change applicable to a financial account of the user, the change configured to improve the user's financial health; and
automatically causing, by the processor, the change to be implemented by a network-accessible financial service.

2. The method of claim 1, wherein the user is a household user including a plurality of individuals, and the data includes data generated by at least two of the plurality of individuals.

3. The method of claim 1, wherein the personality data includes a typical daily activity pattern for the user.

4. The method of claim 3, wherein the obtaining includes generating, by the processor, the typical daily activity pattern.

5. The method of claim 4, wherein the generating includes:
aggregating a set of activity data describing actions of the user over a plurality of days from at least one data source;
identifying at least one regular activity routinely performed at approximately a same time of day, a same day of week, or combination thereof, and
adding the at least one regular activity to the typical daily activity pattern.

6. The method of claim 1, wherein the data includes a transaction prediction for the user.

7. The method of claim 6, further comprising generating, by the processor, the transaction prediction.

8. The method of claim 7, wherein the generating includes:
aggregating a set of transaction data describing transactions of the user over a plurality of days from at least one data source;
identifying at least one frequent transaction performed repeatedly in a substantially same manner by the user;
identifying at least one second user having second personality data at least partially matching the personality data;
identifying at least one second frequent transaction performed repeatedly in a substantially same manner by the at least one second user; and
predicting the transaction by the user based on at least one of the at least one frequent transaction and the at least one second frequent transaction.

9. The method of claim 1, wherein the personality data includes a future goal for the user.

10. The method of claim 9, further comprising generating, by the processor, the future goal.

11. The method of claim 10, wherein the generating includes:
identifying at least one goal within the personality data;
identifying at least one second user having second personality data at least partially matching the personality data;
identifying at least one second goal associated with the at least one second user; and
predicting the future goal based on at least one of the at least one goal and the at least one second goal.

12. The method of claim 1, wherein the data includes a financial volatility for the user.

13. The method of claim 12, further comprising generating, by the processor, the financial volatility.

14. The method of claim 13, wherein the generating includes:
aggregating a set of financial data describing the finances of the user over a plurality of days from at least one data source;
aggregating a set of financial data describing the finances of the user over a plurality of days from at least one data source;
aggregating a set of activity data describing actions of the user over the plurality of days from the at least one data source;
identifying at least one abnormality in the set of financial data, the set of activity data, or a combination thereof, the at least one abnormality indicating financial vulnerability during at least a portion of the plurality of days; and
determining that the financial volatility exists based on the identifying of the at least one abnormality.

15. The method of claim 1, further comprising automatically causing, by the processor, a user interface to suggest a user action configured to improve the user's financial health in response to the analyzing.

16. A system for identifying and implementing an account change comprising:
a non-volatile memory; and
a processor coupled to the memory, the processor configured to:
obtain data indicating a user's financial health, the data including personality data not directly related to finances;
store the data in the memory;
analyze the stored data to identify a change applicable to a financial account of the user, the change configured to improve the user's financial health; and
automatically cause the change to be implemented by a network-accessible financial service in communication with the processor through a network.

17. The system of claim 16, wherein the user is a household user including a plurality of individuals, and the data includes data generated by at least two of the plurality of individuals.

18. The system of claim 16, wherein the personality data includes a typical daily activity pattern for the user.

19. The system of claim 18, wherein the processor is further configured to:
generate the typical daily activity pattern; and
store the typical daily activity pattern in the memory.

20. The system of claim 19, wherein the generating includes:
aggregating a set of activity data describing actions of the user over a plurality of days from at least one data source in communication with the processor through the network;
identifying at least one regular activity routinely performed at approximately a same time of day, a same day of week, or combination thereof; and
adding the at least one regular activity to the typical daily activity pattern.

21. The system of claim 16, wherein the data includes a transaction prediction for the user.

22. The system of claim 21, wherein the processor is further configured to:
generate the transaction prediction; and
store the transaction prediction in the memory.

23. The system of claim 22, wherein the generating includes:
aggregating a set of transaction data describing transactions of the user over a plurality of days from at least one data source in communication with the processor through the network;
identifying at least one frequent transaction performed repeatedly in a substantially same manner by the user;
identifying at least one second user having second personality data at least partially matching the personality data;
identifying at least one second frequent transaction performed repeatedly in a substantially same manner by the at least one second user; and
predicting the transaction by the user based on at least one of the at least one frequent transaction and the at least one second frequent transaction.

24. The system of claim 16, wherein the personality data includes a future goal for the user.

25. The system of claim 24, wherein the processor is further configured to:
generate the future goal; and
store the future goal in the memory.

26. The system of claim 25, wherein the generating includes:
identifying at least one goal within the personality data;
identifying at least one second user having second personality data at least partially matching the personality data;
identifying at least one second goal associated with the at least one second user; and
predicting the future goal based on at least one of the at least one goal and the at least one second goal.

27. The system of claim 16, wherein the data includes a financial volatility for the user.

28. The system of claim 27, wherein the processor is further configured to:
generate the financial volatility; and
store the financial volatility in the memory.

29. The system of claim 28, wherein the generating includes:
aggregating a set of financial data describing the finances of the user over a plurality of days from at least one data source in communication with the processor through the network;
aggregating a set of financial data describing the finances of the user over a plurality of days from at least one data source;
aggregating a set of activity data describing actions of the user over the plurality of days from the at least one data source;
identifying at least one abnormality in the set of financial data, the set of activity data, or a combination thereof, the at least one abnormality indicating financial vulnerability during at least a portion of the plurality of days; and
determining that the financial volatility exists based on the identifying of the at least one abnormality.

30. The system of claim 16, wherein the processor is further configured to automatically cause a user interface of a user device in communication with the processor through the network to suggest a user action configured to improve the user's financial health in response to the analyzing.
